(19) United States
(12) Patent Application Publication
(10) Pub. No.: US 2003/0044069 A1
(43) Pub. Date: Mar. 6, 2003

(54) Handwriting recognition system and method of using the same

(76) Inventor: Yuan-Wan Ku, Bao-Shan (TW)

Correspondence Address: POWELL, GOLDSTEIN, FRAZER & MURPHY LLP, P.O. BOX 97223, WASHINGTON, DC, 20090-7223, US

(21) Appl. No.: 09/943,019

(22) Filed: Aug. 30, 2001

(51) Int. Cl. G06K 9/00

(52) U.S. Cl. 382/187

(57) ABSTRACT

A handwriting recognition system with a wireless pen and a tablet. The wireless pen has an eraser button which is used to let an eraser mode be performed while the eraser button being process, the tablet receive messages from wireless pen and decide the location of wireless pen and current mode of handwriting recognition system. The method of using the handwriting recognition system at least has follows. Move the wireless pen over the tablet so let these messages be received by the tablet, and switch the current mode of the handwriting recognition system between an eraser mode and a writing mode. however, the terminal with coil of the wireless pen always is more closed to the tablet than the other terminal.

### BACKGROUND OF THE INVENTION

1. Field of the Invention

The invention relates to the handwriting recognition system and a method for using the handwriting recognition system, and is most closely related to the handwriting recognition system and corresponding using method that performs the function of eraser without usage of additional software or turning round the wireless pen.

2. Description of the Prior Art

Because the handwriting recognition system could replace the mouse, and is more suitable than the mouse to let the user input words and patterns by user's hands, improvement of the handwriting recognition system is a hot and important filed of current computer technology.

The original of the handwriting recognition system is to replace the mouse. As usual, to enhance the user's convenience, handwriting recognition system usually replaces the mouse by both wireless pen and tablet. Herein, the pen nib of wireless pen usually corresponds to the left button of the mouse.

Clearly, the pervious pen (or the wireless pen) of the handwriting recognition system does have the eraser function. Thus, as the operation of the conventional mouse, if the user wants to erase some words, the user needs to select the words and then to click some icons within the window to select and perform some additional software from the window, to let these selected words be erased.

However, to enhance the user's convenience, one improved wireless pen is present to let the operation of the handwriting recognition system be more similar to the operation of conventional pen. The present wireless pen has two different terminals, one corresponds to the left button of the mouse (the writing mode) and another corresponds to the eraser (the eraser mode). Certainly, two different terminals product different messages with different frequencies. If the user wants to write, as FIG. 1A shows, the user let terminal 101, which corresponds to the left button of mouse, be closed to tablet 11, to activate the writing mode and then to input word(s). In contrast, if the user wants to erase, as FIG. 1B shows, the user let terminal 102, which corresponds to the eraser, be closed to tablet 11, to activate the eraser mode and to erase.

Although the present case could let operation of the wireless pen be similar to the conventional pen which has embedded eraser, the present still has following defects: First, each mode at least has individual capacitor and individual coil, and then total structure of the present wireless pen is complicated. Second, the user must rotate wireless pen to change current working mode, and then operation of the present wireless pen still is not fully convenient.

Accordingly, most of current handwriting recognition systems can not let the wireless pen directly play the function of eraser without application of additional software, other current handwriting recognition systems can not let the wireless pen conveniently switch between the eraser mode and the writing mode. In other words, this still is an open and unsolved problem.

### SUMMARY OF THE INVENTION

One main object of this invention is to provide a handwriting recognition system and a corresponding using method that performs the function of eraser without usage of additional software or turning round the wireless pen.

Another main object of this invention is to provide a handwriting recognition system which is simple in hardware structure so that the manufacturing cost thereof is low.

Still one object of this invention is to provide an easily performing method of providing an eraser function with a handwriting recognition system.

Because the wireless pens must output different messages with different frequencies while different modes being activated, and a popular method of forming different messages is the application of the capacitor-inductor couple circuit. The basic mechanism of this invnetion is to let different modes use different capacitors, with different capacitance, but share the same coil and the same conductor, which is surrounded by the coil Thus, the frequency of the output messages of the wireless pen could be easily changed by using a switch device to change which capacitor is connected with the coil and the conductor. In other words, the activated mode of the handwriting recognition could be easily changed by application of the switch device.

To compare with the conventional handwriting recognition system, indisputably, one main characteristic of this invnetion is that whether the wireless pen is like on to a pen or like on to an eraser is controlled by a switch device. Therefore, because the switch device could be some buttons or a switch on the wireless pen, the user could change activated mode of the wireless pen only by the user's fingers. Significantly, while conventional technology must select additional software from window or turn round wireless pen to change the function of the wireless pen, the invention provide a simpler handwriting recognition system and corresponding using method.

### BRIEF DESCRIPTION OF THE DRAWINGS

A more complete appreciation and many of the attendant advantages will be readily obtained as the same becomes better understood by reference to the following detailed description when considered in connection with the accompanying drawings.

FIG. 1A through FIG. 1B briefly shows the relation between the wireless pen and the tablet under writing mode and eraser mode separately;

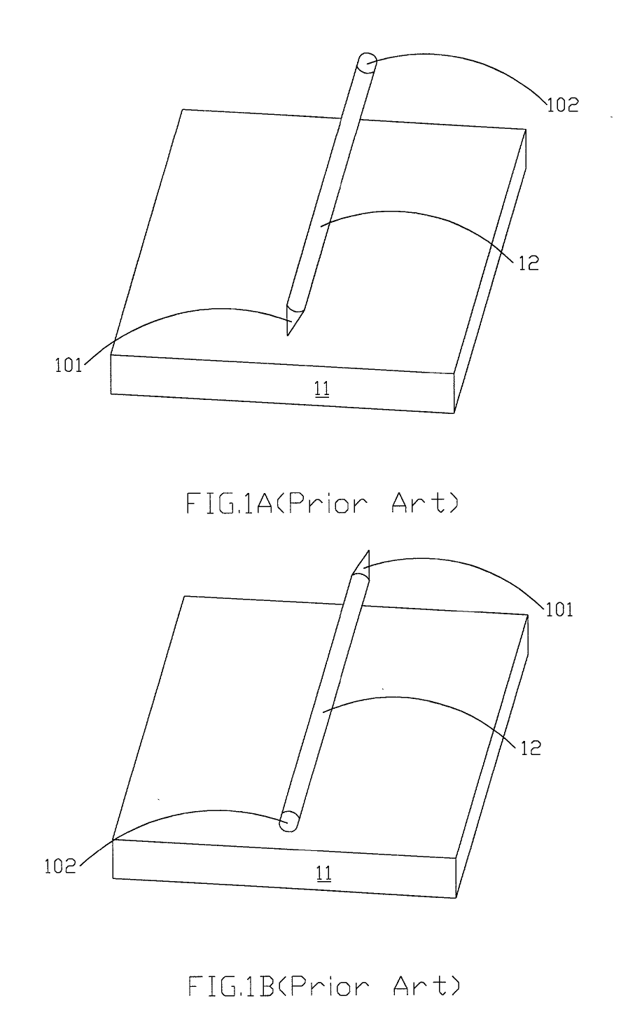

FIG. 2 shows the essential structure of one preferred embodiment;

FIG. 3A through FIG. 3C shows the essential structures of another preferred embodiment separately; and

FIG. 4 shows the essential flow-chart of the other preferred embodiment.

### DESCRIPTION OF THE PREFERRED EMBODIMENT

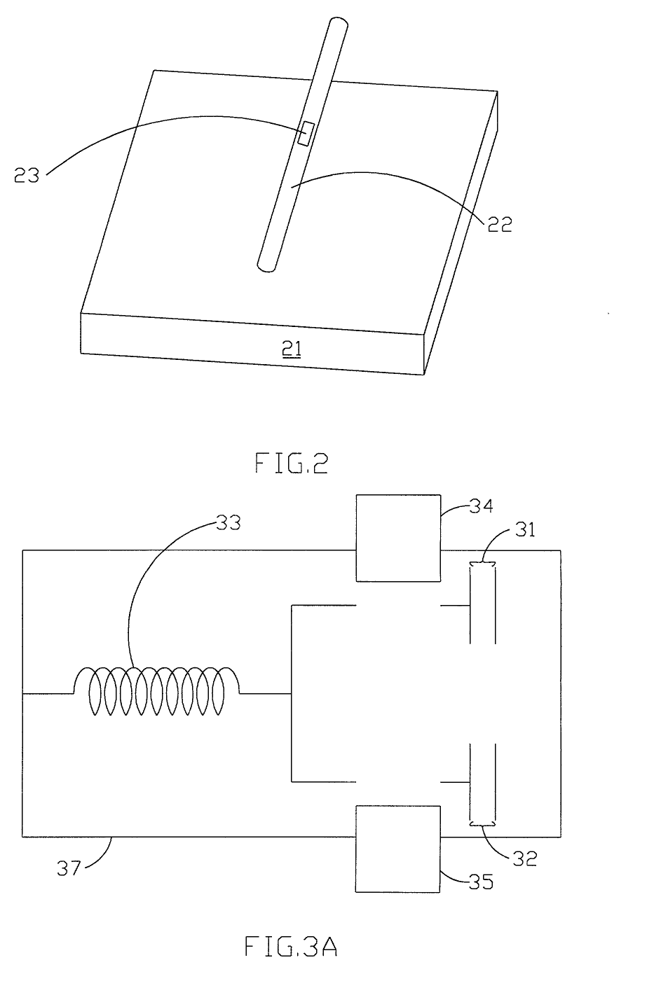

One preferred embodiment of this invention is a handwriting recognition system. As FIG. 2 shows, the handwriting recognition system at least has wireless pen 22 and tablet 21.

Like the conventional technology, tablet 21 is used to receive numerous messages to decide the location of wireless pen 22 and the corresponding mode of the handwriting recognition system. For example, to decide activated function of wireless pen 22 is like on to a pen or like on to an eraser. Herein, these messages are transmitted from wireless pen 22, and the frequencies of different messages are different.

As usual, tablet 21 at least has a sensing loop. Further, the sensing loop usually is located on the two opposite faces of tablet 21, and usually is divided into an X-axis system and an Y-axis system.

However, wireless pen 22 is different to conventional wireless pen, wireless pen 22 at least has eraser mode button 23. The handwriting recognition system would perform an eraser mode, which means wireless pen 22 has the function of eraser, while eraser mode button 23 being pressed. Moreover, wireless pen 22 has only one coil, the eraser mode capacitor which connected with the coil is actived while eraser mode button 23 being pressed, and is connected to other capacitor(s) while eraser mode button 23 being relaxed.

In other words, this embodiment does not activate the function of eraser by selecting additional software from the window, the embodiment also does not activate the function of eraser by turning round the wireless pen to change the property of the terminal of wireless pen which is closed to the tablet. The embodiment activate the function of eraser by directly pressing eraser mode button 23, and then user needs not to change the location of wireless pen 22 or to rotate wireless pen 22.

If wireless pen 22 only has the function of eraser and the function of pen, the handwriting recognition system would perform the eraser mode while eraser mode button 23 being pressed, and the handwriting recognition system would perform the writing mode while eraser mode button 23 being relaxed. Of course, if wireless pen 22 further has the functions which correspond to the middle button and the right button of the mouse, the handwriting recognition system would automatically perform the writing mode while the eraser mode button being relaxed, and would perform the function which correspond to the middle button or the right button of the mouse while corresponding buttons being pressed. However, the essential mechanism of the embodiment that activates the eraser mode by pressing eraser mode button 23 would not be changed.

Furthermore, in order to simplify operation of this embodiment, it is possible to let eraser mode button 23 be automatically relaxed, which means the handwriting recognition system automatically escape the eraser mode, while the distance between wireless pen 22 and tablet 21 exceeding both a predetermined distance during a predetermined period. For example, the predetermined period could be about two to three seconds.

Significantly, the main difference between this embodiment and conventional handwriting recognition system is the wireless pen. For the embodiment, tablet still is used to receive different messages, with different frequencies, which corresponds to different mode and is transmitted from wireless pen, but the wireless pen could activate the eraser mode only by pressing eraser mode button 23.

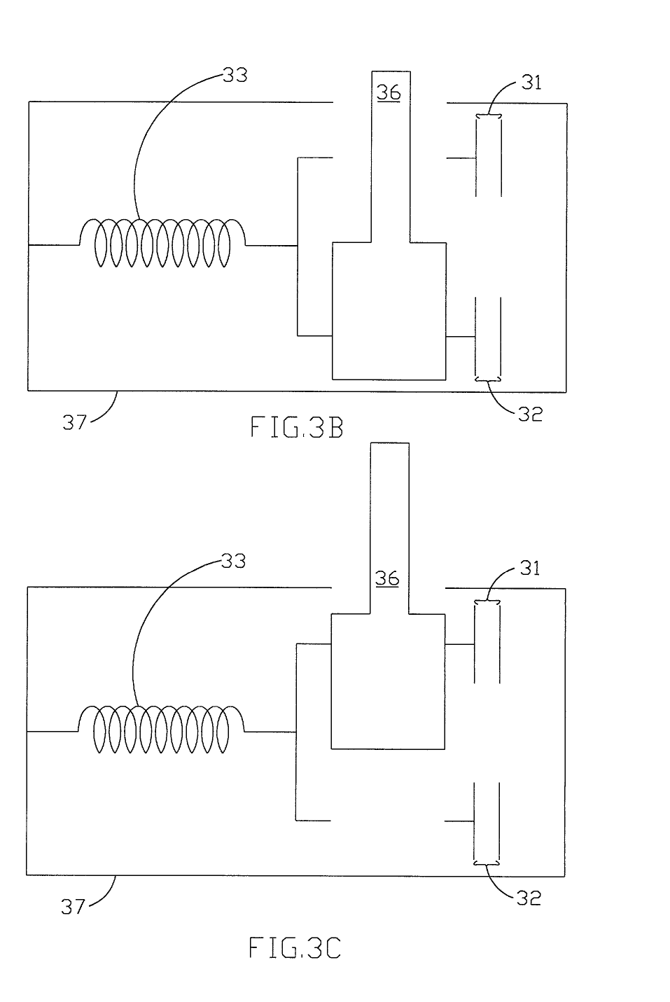

Another preferred embodiment of this invention is a wireless pen. As FIG. 3A shows, the embodiment at least has erase mode capacitor 31, writing mode capacitor 32, coil 33, eraser mode button 34, and writing mode button 35.

In this embodiment, the capacitance of writing mode capacitor 32 is different to the capacitance of eraser mode capacitor 31, but both capacitor 31/32 share same coil 33 which is located in one terminal of the wireless pen. Moreover, coil 33 is only connected with eraser mode capacitor 31 while eraser mode button 34 being pressed, so let a electromagnetic wave with specific frequency is formed by the loop which is made of both eraser mode capacitor 31 and coil 33. Coil 33 is only connected with writing mode capacitor 32 while writing mode button 35 being pressed, so let a electromagnetic wave with another specific frequency is formed by the loop which is made of both writing mode capacitor 32 and coil 33. Certainly, eraser mode button 34 and writing mode button 35 could not be pressed at the same time.

In the embodiment, the frequency of the electromagnetic wave produced by the connection between coil 33 and eraser mode capacitor 31 must be different to the frequency of the electromagnetic wave produced by the connection between coil 33 and writing mode capacitor 35. Thus, the function of wireless pen is like on an eraser while eraser mode button 34 being pressed, and the function of wireless pen is like on a pen while writing mode button 35 being pressed.

Besides, as FIG. 3B and FIG. 3C show, the embodiment could replace both eraser mode capacitor 34 and writing mode button 35 by mode switch device, such as mode switch button 36. Coil 33 is connected with eraser mode capacitor 31 while mode switch device being switched to the eraser mode, and coil 33 is connected with writing mode capacitor 32 while mode switch device being switched to the writing mode. Thus, function of wireless pen could be easily switched only by controlling the mode switch device. However, the detail(s) of this mode switch device is not concerned by this embodiment.

For example, both eraser mode button 34 and writing mode button 35 could be provide by a mode switch button. It is possible to let coil 33 is connected with eraser mode capacitor 31 but not writing mode capacitor 32 while this mode switch button being pressed, and to let coil 33 is connected with writing mode capacitor 32 but not eraser mode capacitor 31 while this mode switch button being relaxed. Certainly, because details of mode switch device is adjustable, it also is possible to let coil 33 is connected with eraser mode capacitor 31 but not writing mode capacitor 32 while this mode switch button being relaxed, and to let coil 33 is connected with writing mode capacitor 32 but not eraser mode capacitor 31 while this mode switch button being pressed.

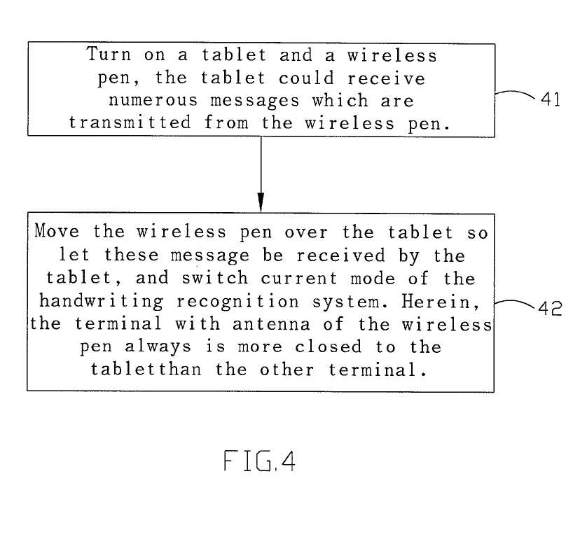

Still a preferred embodiment is a method of using a handwriting recognition system. As FIG. 4 shows, the essential flow chart has following steps.

As active block 41 shows, turn on a tablet and a wireless pen, the tablet could receive numerous messages which are transmitted from the wireless pen.

As operation block 42 shows, move the wireless pen over the tablet so let these message be received by the tablet, and switch current mode of the handwriting recognition system. Herein, the terminal with coil of wireless pen always is more closed to tablet than the other terminal.

In this embodiment, the switch of current mode could be achieved by pressing an erase mode button to activate an eraser mode and by pressing a writing mode button to activate a writing mode. Where both eraser mode button and writing mode button are located in and on the wireless pen, and both buttons usually are neighboring for the user's convenience.

In addition, the switch of current mode also could be achieved by changing the distance between the wireless pen and the tablet to change the strength of these messages. Herein, current mode of the handwriting recognition system is automatically switched whenever the strength of message is less a predetermined strength.

From the foregoing it will be appreciated that, although specific embodiments of the invention have been described herein for the purpose of illustration, various modifications may be made without deviating from the spirit and scope of the invention. Accordingly, the invention is not limited except as by the appended claims.

What is claimed is

1. A handwriting recognition system, comprising:
a wireless pen, said wireless pen comprising an eraser mode button, said handwriting recognition system performing an eraser mode while said eraser mode button being pressed; and
a tablet, said tablet receiving a plurality of messages to decide the location of said wireless pen and the corresponding mode of said handwriting recognition system, said messages are transmitted from said wireless pen.

2. The handwriting recognition system of claim 1, said handwriting recognition system performing a writing mode while said eraser mode being relaxed.

3. The handwriting recognition system of claim 1, while the distance between said wireless pen and said tablet exceeding a predetermined distance during a predetermined period, said eraser button being automatically relaxed and then said handwriting recognition system automatically escaping said eraser mode.

4. The handwriting recognition system of claim 3, said handwriting recognition system automatically escaping said eraser button mode and performing a writing mode.

5. The handwriting recognition system of claim 3, said predetermined period being about 2 to 3 seconds.

6. The handwriting recognition system of claim 1, the frequency of said handwriting recognition system being changed while the corresponding mode of said handwriting recognition system being changed.

7. The handwriting recognition system of claim 1, said tablet comprising a sensing loop.

8. The handwriting recognition system of claim 7, said sensing loop being located on the two opposite faces of said tablet.

9. The handwriting recognition system of claim 7, said sensing loop being divided into an X-axis system and an Y-axis system.

10. The handwriting recognition system of claim 1, said wireless pen having only one coil, said coil connecting with an eraser mode capacitor while said eraser mode being pressed, and said coil being separating away said eraser mode capacitor while said eraser button being relaxed.

11. A wireless pen, comprising:
an eraser mode capacitor;
a writing mode capacitor, the capacitance of said writing mode capacitor being different to the capacitance of said eraser mode capacitor;
a coil which is located in one terminal of said wireless pen;
an eraser mode button, said coil being only connected with said eraser mode capacitor while said eraser mode button being pressed; and
a writing mode button, said coil being only connected with said writing mode capacitor while said writing mode button being pressed.

12. The wireless pen of claim 11, the frequency of the electromagnetic wave produced by the connection between said coil and said eraser mode capacitor being different to the frequency of the electromagnetic wave produced by the connection between said coil and said writing mode capacitor.

13. The wireless pen of claim 11, the function of said wireless pen being like on an eraser while said eraser mode button being pressed.

14. The wireless pen of claim 11, the function of said wireless pen being like on a pen while said writing mode button being pressed.

15. The wireless pen of claim 11, both said eraser mode button and said writing mode button being providing by a mode switch button, said coil being connected with said eraser mode capacitor while said mode switch button being pressed, and said coil being connected with said writing mode capacitor while said mode switch button being relaxed.

16. The wireless pen of claim 11, both said eraser mode button and said writing mode button being providing by a mode switch button, said coil being connected with said eraser mode capacitor while said mode switch button being relaxed, and said coil being connected with said writing mode capacitor while said mode switch button being pressed.

17. The wireless pen of claim 11, both said eraser mode button and said writing mode button being providing by a mode switch device, said coil being connected with said eraser mode capacitor while said mode switch button being switched to said eraser mode, and said coil being connected with said writing mode capacitor while said mode switch button being switched to said writing mode.

18. A method of using a handwriting recognition system; comprising:
turning on a tablet and a wireless pen, said tablet being used to receive a plurality of messages which are transmitted from said wireless pen; and
moving said wireless pen over said tablet so let said message be received by said tablet, and switching the current mode of said handwriting recognition system, wherein the terminal with coil of said wireless pen always is more closed to said tablet than the other terminal.

19. The method of claim 18, further comprising the step of pressing an erase mode button to activate an eraser mode and the step of pressing a writing mode button to activate a writing mode, wherein both said eraser mode button and said writing mode button are located in and on said wireless pen.

20. The method of claim 18, further comprising the step of changing the distance between said wireless pen and said tablet to change the strength of said messages, wherein current mode of said handwriting recognition system being switched whenever the strength of message being less a predetermined strength.
